(19) United States
(12) Patent Application Publication
(10) Pub. No.: US 2023/0155180 A1
(43) Pub. Date: May 18, 2023

(54) ENERGY STORAGE DEVICE, METHOD FOR MANUFACTURING THE SAME AND ENERGY STORAGE APPARATUS

(71) Applicant: GS Yuasa International Ltd., Kyoto-shi, Kyoto (JP)

(72) Inventor: Norio YAMATANI, Kyoto (JP)

(21) Appl. No.: 17/915,128

(22) PCT Filed: Mar. 24, 2021
(86) PCT No.: PCT/JP2021/012131

§ 371 Date: Sep. 28, 2022

(30) Foreign Application Priority Data
Mar. 31, 2020 (JP) 2020-064347

(51) Int. Cl. H01M 10/0585; H01M 4/525; H01M 4/30

(52) U.S. Cl. CPC H01M 10/0585; H01M 4/525; H01M 4/30; H01M 2004/028

(57) ABSTRACT

An energy storage device according to one aspect of the present invention includes: an electrode assembly including a positive electrode, a negative electrode, and a separator; a nonaqueous electrolyte; and a case for housing the electrode assembly and the nonaqueous electrolyte, in which the positive electrode contains a positive active material, the positive active material contains a plurality of particles satisfying at least one of conditions (1) and (2) below, and the electrode assembly is in a pressed state. (1) A plurality of primary particles that do not form secondary particles (2) A plurality of secondary particles formed by aggregation of a plurality of primary particles, having a ratio of an average diameter of the secondary particles to an average diameter of the primary particles that form the secondary particles of less than 11

### TECHNICAL FIELD

The present disclosure relates to an energy storage device, a method for manufacturing the same, and an energy storage apparatus.

### BACKGROUND ART

Secondary batteries typified by lithium ion secondary batteries are used for electronic equipment such as personal computers and communication terminals, automobiles, and the like because the batteries have high energy density.

As the secondary battery, for example, there is disclosed a flat nonaqueous electrolyte secondary battery including a flat electrode assembly having a structure in which a positive electrode plate and a negative electrode plate are laminated with a separator interposed therebetween, and a nonaqueous electrolyte solution, in which a pressure of 8.83×10⁻² MPa or more is applied to the electrode assembly of the flat nonaqueous electrolyte secondary battery by applying a pressure in the lamination direction of the positive electrode plate, the negative electrode plate and the separator from the outside (see JP-A-2018-26352).

### PRIOR ART DOCUMENT

### Patent Document

Patent Document 1: JP-A-2018-26352

### SUMMARY OF THE INVENTION

### Problems to be Solved by the Invention

Resistance of the flat nonaqueous electrolyte secondary battery may increase due to repeated charge-discharge.

In view of the above circumstances, an object of the present invention is to provide an energy storage device in which an increase in resistance associated with a charge-discharge cycle is suppressed, a method for manufacturing the energy storage device, and an energy storage apparatus including the energy storage device.

### Means for Solving the Problems

An energy storage device according to one aspect of the present invention includes: an electrode assembly including a positive electrode, a negative electrode, and a separator; a nonaqueous electrolyte; and a case for housing the electrode assembly and the nonaqueous electrolyte, in which the positive electrode contains a positive active material, the positive active material contains a plurality of particles satisfying at least one of conditions (1) and (2) below, and the electrode assembly is in a pressed state.

(1) A plurality of primary particles that do not form secondary particles

(2) A plurality of secondary particles formed by aggregation of a plurality of primary particles, having a ratio of an average diameter of the secondary particles to an average diameter of the primary particles that form the secondary particles of less than 11

A method for manufacturing an energy storage device according to another aspect of the present invention is a method for manufacturing an energy storage device including an electrode assembly including a positive electrode, a negative electrode, and a separator, a nonaqueous electrolyte, and a case for housing the electrode assembly and the nonaqueous electrolyte, the method including pressing the electrode assembly, in which the positive electrode contains a positive active material, and the positive active material contains a plurality of particles satisfying at least one of conditions (1) and (2) below.

(1) A plurality of primary particles that do not form secondary particles

(2) A plurality of secondary particles formed by aggregation of a plurality of primary particles, having a ratio of an average diameter of the secondary particles to an average diameter of the primary particles that form the secondary particles of less than 11

An energy storage apparatus according to another aspect of the present invention includes one or more the energy storage devices and a pressing member, and the pressing member presses the electrode assembly of the energy storage device by pressing the case.

### Advantages of the Invention

According to the energy storage device according to one aspect of the present invention, it is possible to suppress an increase in resistance associated with a charge-discharge cycle.

According to the method for manufacturing an energy storage device according to another aspect of the present invention, it is possible to manufacture an energy storage device in which an increase in resistance associated with a charge-discharge cycle is suppressed.

According to the energy storage apparatus according to another aspect of the present invention, it is possible to suppress an increase in resistance associated with a charge-discharge cycle.

### BRIEF DESCRIPTION OF THE DRAWINGS

FIG. 1 is an external perspective view showing an embodiment of an energy storage device.

FIG. 2 is a schematic diagram showing an embodiment of a battery pack including a plurality of energy storage devices.

FIG. 3 is a schematic perspective view showing an embodiment of an energy storage apparatus including a plurality of energy storage devices.

### MODE FOR CARRYING OUT THE INVENTION

First, outlines of an energy storage device, a method for manufacturing the energy storage device, and an energy storage apparatus disclosed in the present specification will be described.

An energy storage device according to one aspect of the present invention includes: an electrode assembly including a positive electrode, a negative electrode, and a separator; a nonaqueous electrolyte; and a case for housing the electrode assembly and the nonaqueous electrolyte, in which the positive electrode contains a positive active material, the positive active material contains a plurality of particles satisfying at least one of conditions (1) and (2) below, and the electrode assembly is in a pressed state.

(1) A plurality of primary particles that do not form secondary particles

(2) A plurality of secondary particles formed by aggregation of a plurality of primary particles, having a ratio of an average diameter of the secondary particles to an average diameter of the primary particles that form the secondary particles of less than 11

When the energy storage device is repeatedly charged and discharged, the positive active material expands. When secondary particles in which a plurality of primary particles are aggregated are used as the positive active material, cracks are generated at grain boundaries of the plurality of primary particles due to the expansion, and resistance on the surface of the positive active material increases due to the generation of crack. As the number of primary particles constituting the secondary particles is larger, an increase in resistance due to generation of crack is more remarkable.

However, according to the energy storage device, the plurality of particles contained in the positive active material are a plurality of primary particles that do not form secondary particles or are secondary particles formed by aggregation of a plurality of primary particles, the ratio of the average diameter of the secondary particles to the average diameter of the primary particles that form the secondary particles is within the above range, and also the electrode assembly is in a pressed state, whereby expansion of the positive active material due to repetition of charging and discharging is suppressed. By suppressing the expansion, the generation of crack is reduced, and an increase in resistance on the surface of the positive active material is reduced.

Therefore, according to the energy storage device, it is possible to suppress an increase in resistance associated with a charge-discharge cycle.

Here, the pressure applied to the electrode assembly may be 0.1 MPa or more.

When the pressure is 0.1 MPa or more as described above, an increase in resistance associated with a charge-discharge cycle can be further suppressed.

Here, the positive active material may be a transition metal oxide containing nickel, and a product of a BET specific surface area and a median diameter of the positive active material may be 4.5 or less.

When secondary particles in which a plurality of primary particles are aggregated are used as the positive active material, the BET specific surface area of the positive active material increases due to irregularities on the surface of the secondary particle and cracks generated at the grain boundaries of the primary particles, and the contact area between the positive active material and the nonaqueous electrolyte increases. This increases the resistance on the surface of the positive active material. Therefore, it is presumed that the resistance increase due to a reaction with the nonaqueous electrolyte decreases as the positive active material particle is closer to an ideal sphere having no irregularities or cracks on the surface. In an ideal sphere, the BET specific surface area is expressed by the following equation.

BET Specific surface area (m²/g)=4π×(Median diameter (μm)/2)²/{(4π/3)×(Median diameter (μm)/2)³ ×True density (g/cm³)}

The following equation is derived by modification of the above equation.

BET Specific surface area (m²/g)×Median diameter (μm)=6/True density (g/cm³)

Here, as an example of the transition metal oxide containing nickel, the true density of LiNiO₂ is about 4.7 (g/cm³), thus, in the case of an ideal sphere, the product of the BET specific surface area and the median diameter is about 1.3. In practice, since the positive active material particle has minute irregularities and cracks on the surface, the product of the BET specific surface area and the median diameter is larger than 1.3. However, by setting the product to 4.5 or less, an increase in resistance associated with a charge-discharge cycle can be further suppressed. When the positive active material contains a plurality of particles satisfying at least one of conditions (1) and (2) below, the product of the BET specific surface area and the median diameter can be reduced.

(1) A plurality of primary particles that do not form secondary particles

(2) A plurality of secondary particles formed by aggregation of a plurality of primary particles, having a ratio of an average diameter of the secondary particles to an average diameter of the primary particles that form the secondary particles of less than 11

A method for manufacturing an energy storage device according to another aspect of the present invention is a method for manufacturing an energy storage device including an electrode assembly including a positive electrode, a negative electrode, and a separator, a nonaqueous electrolyte, and a case for housing the electrode assembly and the nonaqueous electrolyte, the method including pressing the electrode assembly, in which the positive electrode contains a positive active material, and the positive active material contains a plurality of particles satisfying at least one of conditions (1) and (2) below.

(1) A plurality of primary particles that do not form secondary particles

(2) A plurality of secondary particles formed by aggregation of a plurality of primary particles, having a ratio of an average diameter of the secondary particles to an average diameter of the primary particles that form the secondary particles of less than 11

According to this method for manufacturing an energy storage device, it is possible to manufacture the energy storage device in which the plurality of particles contained in the positive active material are a plurality of primary particles that do not form secondary particles or are secondary particles formed by aggregation of the plurality of primary particles, the ratio of the average diameter of the secondary particles to the average diameter of the primary particles that form the secondary particles is within the above range, and also the electrode assembly is in a pressed state.

Therefore, as described above, according to the method for manufacturing an energy storage device, it is possible to manufacture an energy storage device in which an increase in resistance associated with a charge-discharge cycle is suppressed.

Here, the pressure applied to the electrode assembly may be 0.1 MPa or more.

When the pressure is 0.1 MPa or more as described above, it is possible to manufacture an energy storage device in which an increase in resistance associated with a charge-discharge cycle is further suppressed.

The method for manufacturing an energy storage device may further include initially charging and discharging the energy storage device, in which the pressing the electrode assembly may be performed after the initially charging and discharging.

When the electrode assembly is pressed after performing the initial charge-discharge as described above, the nonaqueous electrolyte is decomposed by the initial charge-discharge, and the generated gas can be discharged from the inside of the electrode assembly. The presence of gas between the positive and negative electrodes is one of the causes of an increase in resistance between the positive and negative electrodes. Accordingly, it is possible to manufacture an energy storage device in which initial resistance is low and an increase in resistance associated with a charge-discharge cycle is suppressed.

An energy storage apparatus according to another aspect of the present invention includes one or more the energy storage devices and a pressing member, and the pressing member presses the electrode assembly of the energy storage device by pressing the case.

According to this energy storage apparatus, since the electrode assembly of the energy storage device is in a state of being pressed by the pressing member, as described above, an increase in resistance associated with a charge-discharge cycle can be suppressed.

The configuration of an energy storage device, the configuration of an energy storage apparatus, a method for manufacturing the energy storage device, and a method for manufacturing the energy storage apparatus, according to an embodiment of the present invention, and other embodiments will be described in detail. The names of the respective constituent members (respective constituent elements) used in the respective embodiments may be different from the names of the respective constituent members (respective constituent elements) used in the background art.

<Configuration of energy storage device>

An energy storage device according to an embodiment of the present invention includes a positive electrode, a negative electrode and a nonaqueous electrolyte. The positive electrode and the negative electrode usually form an electrode assembly stacked or wound with a separator interposed therebetween. The electrode assembly is housed in a case, and the case is filled with the nonaqueous electrolyte. The nonaqueous electrolyte is interposed between the positive electrode and the negative electrode. A nonaqueous electrolyte secondary battery (hereinafter, also simply referred to as a “secondary battery”) will be described as an example of the energy storage device.

### (Positive Electrode)

The positive electrode has a positive electrode substrate and a positive active material layer disposed directly on the positive electrode substrate or over the positive electrode substrate with an intermediate layer interposed therebetween.

The positive electrode substrate has conductivity. Having “conductivity” means having a volume resistivity of 10⁷ Ω·cm or less that is measured in accordance with JIS-H-0505 (1975), and the term “non-conductivity” means that the volume resistivity is more than 10⁷ Ω·cm. As the material of the positive electrode substrate, a metal such as aluminum, titanium, tantalum, or stainless steel, or an alloy thereof is used. Among these, aluminum or an aluminum alloy is preferable from the viewpoint of electric potential resistance, high conductivity, and costs. Examples of the positive electrode substrate include a foil, a deposited film, a mesh, and a porous material, and a foil is preferable from the viewpoint of costs. Therefore, the positive electrode substrate is preferably an aluminum foil or an aluminum alloy foil. Examples of the aluminum or aluminum alloy include A1085, A3003, A1N30, and the like specified in JIS-H-4000 (2014) or JIS-H-4160 (2006).

The average thickness of the positive electrode substrate is preferably 3 μm or more and 50 μm or less, more preferably 5 μm or more and 40 μm or less, still more preferably 8 μm or more and 30 μm or less, and particularly preferably 10 μm or more and 25 μm or less. By setting the average thickness of the positive electrode substrate in the above-described range, it is possible to enhance the energy density per volume of a secondary battery while increasing the strength of the positive electrode substrate. The term “average thickness” refers to a value obtained by dividing the cutout mass in cutout of a substrate having a predetermined area by the true density and cutout area of the substrate. The same definition applies when the “average thickness” is used for other members and the like.

The intermediate layer is a layer arranged between the positive electrode substrate and the positive active material layer. The intermediate layer contains a conductive agent such as carbon particles to reduce contact resistance between the positive electrode substrate and the positive active material layer. The configuration of the intermediate layer is not particularly limited, and includes, for example, a binder and a conductive agent.

The positive active material layer includes a positive active material. The positive active material layer contains optional components such as a conductive agent, a binder (binding agent), a thickener, a filler, or the like as necessary.

The positive active material can be appropriately selected from known positive active materials. As the positive active material for a lithium ion secondary battery, a material capable of storing and releasing lithium ions is usually used. Examples of the positive active material include lithium transition metal composite oxides having an α-NaFeO₂-type crystal structure, lithium-transition metal oxides having a spinel-type crystal structure, polyanion compounds, chalcogenides, and sulfur.

Examples of the lithium transition metal composite oxide having an α-NaFeO₂-type crystal structure include Li[LiₓNi₍₁₋ₓ₎]O₂ (0≤x≤0.5), Li[LiₓNi_{y}Co_{(1-x-y)}]O₂ (0≤x≤0.5, 0<y<1), Li[LiₓCo₍₁₋ₓ₎]O₂ (0≤x≤0.5), Li[LiₓNi_{y}Mn_{(1-x-y)}]O₂ (0≤x≤0.5, 0<y<1), Li[LiₓNi_{y}Mn_{β}Co_{(1-x-y-β)}](0≤x≤0.5, 0<y, 0<13, 0.5<y+β<1), and Li[LiₓNi_{y}Co_{β}Al_{(1-x-y-β)}O₂ (0≤x<0.5, 0<y, 0<13, 0.5<y+β<1). Examples of the lithium transition metal composite oxide having a spinel-type crystal structure include LiFeMn₂O₄ and LiₓNi_{y}Mn_{(2-y)}O₄. Examples of the polyanion compound include LiFePO₄, LiMnPO₄, LiNiPO₄, LiCoPO₄, Li₃V₂(PO₄)₃, Li₂MnSiO₄, and Li₂CoPO₄F. Examples of the chalcogenide include titanium disulfide, molybdenum disulfide, and molybdenum dioxide. Apart of atoms or polyanions in these materials may be substituted with atoms or anion species composed of other elements. The surfaces of these materials may be coated with other materials. In the positive active material layer, one of these materials may be used singly, or two or more thereof may be used in mixture.

As the positive active material, a lithium transition metal composite oxide containing nickel is preferable, a lithium transition metal composite oxide containing nickel, cobalt, and manganese or aluminum is more preferable, and a lithium transition metal composite oxide containing nickel, cobalt, and manganese is still more preferable. The lithium transition metal composite oxide preferably has an α-NaFeO₂-type crystal structure. By using such a lithium transition metal composite oxide, the energy density can be increased, and the like.

The positive active material is a particle (powder). More specifically, the positive active material contains a plurality of particles satisfying at least one of conditions (1) and (2) below.

(1) A plurality of primary particles that do not form secondary particles

(2) A plurality of secondary particles formed by aggregation of a plurality of primary particles, having a ratio of an average diameter of the secondary particles to an average diameter of the primary particles that form the secondary particles of less than 11

When the positive active material satisfies the condition (1), the average diameter of the primary particles is, for example, preferably 0.1 μm or more and 10 μm or less, and more preferably 0.5 μm or more and 7 μm or less. The term “average diameter of the primary particles” means a value determined by measuring the average diameters of at least 50 primary particles in a scanning electron microscope observation image of a cross section obtained by cutting the positive active material layer in the thickness direction, and averaging the measured values. The average diameter of each primary particle is determined as follows. The shortest diameter passing through the center of the minimum circumscribed circle of the primary particle is defined as a minor axis, and the diameter passing through the center and orthogonal to the minor axis is defined as a major axis. The average value of the major axis and the minor axis is defined as the average diameter of the primary particle. When there are two or more shortest diameters, a shortest diameter with the longest orthogonal diameter is defined as a minor axis.

When the positive active material satisfies the condition (2), the upper limit of the ratio of the average diameter of the secondary particles to the average diameter of the primary particles is less than 11, and is preferably 8, more preferably 6, still more preferably 4, and further preferably 3 in some cases. The ratio is less than the upper limit, whereby generation of crack associated with a charge-discharge cycle can be more reliably reduced, and an increase in resistance can be more reliably suppressed. The lower limit of the ratio of the average diameter of the secondary particles to the average diameter of the primary particles may be 1. From the difference between the method for measuring the average diameter of the primary particles and the method for measuring the average diameter of the secondary particles, the lower limit of the ratio of the average diameter of the secondary particles to the average diameter of the primary particles is not necessarily 1, and may be less than 1, for example, 0.9.

The average diameter of the primary particles can be appropriately set, for example, in consideration of the relationship with the average diameter of the secondary particles such that the ratio of the average diameter of the secondary particles with respect to the average diameter of the primary particles is less than 11. For example, the average diameter of the primary particles is preferably 0.1 μm or more and 10 μm or less, and more preferably 0.5 μm or more and 7 μm or less. When the positive active material contains a plurality of primary particles that do not form secondary particles and secondary particles formed by aggregation of the plurality of primary particles, both the average diameter of the primary particles contained independently of the secondary particles and the average diameter of the primary particles constituting the secondary particles are preferably within the above range. When the positive active material contains only the secondary particles, the average diameter of the primary particles constituting the secondary particles is preferably within the above range.

By setting the average diameter of the primary particles to be equal to or more than the above lower limit, the positive active material is easily produced or handled. By setting the average diameter of the primary particles to be equal to or less than the above upper limit, the electron conductivity of the positive active material layer is improved. In addition, by setting the average diameter of the primary particles within the above range, it is easy to set the ratio of the average diameter of the secondary particles to the average diameter of the primary particles to less than 11, so that an increase in resistance associated with a charge-discharge cycle can be more reliably suppressed.

The average diameter of the secondary particles can be appropriately set, for example, in consideration of the relationship with the average diameter of the primary particles such that the average diameter of the secondary particles with respect to the average diameter of the primary particles is less than 11. For example, the average diameter of the secondary particles is preferably 1 μm or more and 20 μm or less, and more preferably 2 μm or more and 15 μm or less. When a composite of the positive active material and another material is used as the secondary particles, the average diameter of the composite is defined as the average diameter of the secondary particles. The term “average diameter of the secondary particles” means a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013).

By setting the average diameter of the secondary particles to be equal to or more than the above lower limit, the positive active material is easily produced or handled. By setting the average diameter of the secondary particles to be equal to or less than the above upper limit, the electron conductivity of the positive active material layer is improved. In addition, by setting the average diameter of the secondary particles within the above range, it is easy to set the ratio of the average diameter of the secondary particles to the average diameter of the primary particles to less than 11, so that an increase in resistance associated with a charge-discharge cycle can be more reliably suppressed.

The upper limit of the product of the BET specific surface area and the median diameter of the positive active material is not particularly limited, but is preferably 4.5 or less, more preferably 4.0 or less, still more preferably 3.0 or less, and further preferably 2.5 or less in some cases. By setting the product of the BET specific surface area and the median diameter to be equal to or less than the above upper limit, an increase in resistance associated with a charge-discharge cycle can be further suppressed. The lower limit of the product of the BET specific surface area and the median diameter of the positive active material is not particularly limited, but may be 1.3.

The upper limit of the BET specific surface area of the positive active material is not particularly limited, but is, for example, preferably 1.0 m²/g, and more preferably 0.7 m²/g. The lower limit of the BET specific surface area of the positive active material is not particularly limited, but is, for example, preferably 0.2 m²/g, and more preferably 0.3 m²/g. By setting the BET specific surface area of the positive active material in the above range, the contact area between the nonaqueous electrolyte and the positive active material particles can be reduced, so that an increase in resistance associated with a charge-discharge cycle can be further suppressed. The term “BET specific surface area of the positive active material” is determined by immersing the positive active material in liquid nitrogen, and measuring pressure and an adsorption amount of nitrogen at that time based on the fact that nitrogen molecules are physically adsorbed on the particle surface by supplying nitrogen gas.

Specifically, the BET specific surface area is measured by the following method. An adsorption amount (m²) of nitrogen on a sample is determined by one point method using a specific surface area measurement apparatus manufactured by YUASA IONICS Co., Ltd. (trade name: MONOSORB). A value obtained by dividing the obtained adsorption amount by a mass (g) of the sample is defined as the BET specific surface area (m²/g). In the measurement, gas adsorption by cooling using liquid nitrogen is performed. In addition, preheating is performed at 120° C. for 15 minutes before cooling. An amount of the measurement sample loaded is 0.5 g ±0.01 g. A sample of the positive active material to be subjected to the measurement of the BET specific surface area is prepared by the following method.

The energy storage device is discharged with a current of 0.1C until the voltage becomes an end-of-discharge voltage under normal usage, so that the energy storage device is brought to a completely discharged state. Here, the term “under normal usage” means use of the energy storage device while employing discharge conditions recommended or specified in the energy storage device. The energy storage device in a completely discharged state is disassembled, the positive electrode is taken out as a working electrode, a half battery is assembled with metal Li as a counter electrode, and discharge is performed at a current of 0.1C until a positive electrode potential reaches 3.0 V (vs. Li/Li⁺). The half battery is disassembled, and the taken-out positive electrode is sufficiently washed with dimethyl carbonate, and then dried under reduced pressure at room temperature. The positive composite layer is peeled off from the dried positive electrode using, for example, a spatula, and the binder, the conductive agent, and the like are removed to separate the positive active material, and the positive active material is used as a sample of the positive active material in the measurement of the BET specific surface area. The binder is removed by immersing the positive composite layer in an organic solvent or the like, followed by filtration. The conductive agent is removed by heat treatment at about 750° C. in an air atmosphere. The operations from disassembling to drying under reduced pressure of the battery are performed in a dry atmosphere having a dew point of −40° C. or lower.

The median diameter of the positive active material is, for example, preferably 0.5 μm or more and 20 μm or less, and more preferably 1 μm or more and 15 μm or less. By setting the median diameter of the positive active material to be equal to or greater than the above lower limit, the positive active material is easily produced or handled. By setting the median diameter of the positive active material to be equal to or less than the above upper limit, the electron conductivity of the positive active material layer is improved. The term “median diameter of the positive active material” means a value at which a volume-based integrated distribution calculated in accordance with JIS-Z-8819-2 (2001) is 50% based on a particle size distribution measured by a laser diffraction/scattering method for a diluted solution obtained by diluting positive active material particles with a solvent in accordance with JIS-Z-8825 (2013). When the positive active material is a plurality of primary particles that do not form secondary particles, the average diameter of the primary particles may not coincide with the median diameter due to a difference between the method for measuring the average diameter of the primary particles and the method for measuring the median diameter. When the positive active material is a plurality of secondary particles formed by aggregation of a plurality of primary particles and having a ratio of the average diameter to the average diameter of the primary particles of less than 11, the median diameter is equal to the average diameter of the secondary particles.

In order to obtain primary particles not forming secondary particles and secondary particles in which the primary particles are aggregated with a predetermined particle diameter, a pulverizer, a classifier, or the like is used. Examples of a crushing method include a method in which a mortar, a ball mill, a sand mill, a vibratory ball mill, a planetary ball mill, a jet mill, a counter jet mill, a whirling airflow type jet mill, or a sieve or the like is used. At the time of crushing, wet type crushing in the presence of water or an organic solvent such as hexane can also be used. As a classification method, a sieve or a wind force classifier or the like is used based on the necessity both in dry manner and in wet manner. In addition, the plurality of primary particles can be sintered to have a large particle size by, for example, increasing the firing temperature of the active material or prolonging the firing time.

The content of the positive active material in the positive active material layer is preferably 50% by mass or more and 99% by mass or less, more preferably 70% by mass or more and 98% by mass or less, and still more preferably 80% by mass or more and 95% by mass or less. By setting the content of the positive active material in the above range, it is possible to achieve both high energy density and productivity of the positive active material layer.

### (Optional Components)

The conductive agent is not particularly limited as long as it is a material exhibiting conductivity. Examples of such a conductive agent include carbonaceous materials, metals, and conductive ceramics. Examples of the carbonaceous materials include graphite, non-graphitic carbon, and graphene-based carbon. Examples of the non-graphitic carbon include carbon nanofibers, pitch-based carbon fibers, and carbon black. Examples of the carbon black include furnace black, acetylene black, and ketjen black. Examples of the graphene-based carbon include graphene, carbon nanotubes (CNTs), and fullerene. Examples of the shape of the conductive agent include a powdery shape and a fibrous shape. As the conductive agent, one of these materials may be used singly or two or more of these materials may be used in mixture. These materials may be composited and used. For example, a material obtained by compositing carbon black with CNT may be used. Among these, carbon black is preferable from the viewpoint of electron conductivity and coatability, and in particular, acetylene black is preferable.

The content of the conductive agent in the positive active material layer is preferably 0.5% by mass or more and 10% by mass or less, and more preferably 1% by mass or more and 9% by mass or less. By setting the content of the conductive agent in the above range, the energy density of the secondary battery can be enhanced.

Examples of the binder include: thermoplastic resins such as fluororesin (polytetrafluoroethylene (PTFE), polyvinylidene fluoride (PVDF), etc.), polyethylene, polypropylene, polyacryl, and polyimide; elastomers such as an ethylene-propylene-diene rubber (EPDM), sulfonated EPDM, a styrene butadiene rubber (SBR), and a fluororubber; and polysaccharide polymers.

The content of the binder in the positive active material layer is preferably 0.5% by mass or more and 10% by mass or less, and more preferably 1% by mass or more and 9% by mass or less. By setting the content of the binder in the above range, the active material can be stably held.

Examples of the thickener include polysaccharide polymers such as carboxymethylcellulose (CMC) and methylcellulose. When the thickener has a functional group that is reactive with lithium and the like, the functional group may be deactivated by methylation or the like in advance.

The filler is not particularly limited. Examples of the filler include polyolefins such as polypropylene and polyethylene, inorganic oxides such as silicon dioxide, alumina, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, and barium sulfate, nitrides such as aluminum nitride and silicon nitride, and substances derived from mineral resources, such as talc, montmorillonite, boehmite, zeolite, apatite, kaolin, mullite, spinel, olivine, sericite, bentonite and mica, or artificial products thereof.

The positive active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Nb, or W as a component other than the positive active material, the conductive agent, the binder, the thickener, and the filler.

### (Negative Electrode)

The negative electrode has a negative electrode substrate and a negative active material layer disposed directly on the negative electrode substrate or over the negative electrode substrate with an intermediate layer interposed therebetween. The configuration of the intermediate layer is not particularly limited, and for example can be selected from the configurations exemplified for the positive electrode.

The negative electrode substrate exhibits conductivity. As the material of the negative electrode substrate, a metal such as copper, nickel, stainless steel, nickel-plated steel, or aluminum, or an alloy thereof is used.

Among these, copper or a copper alloy is preferable. Examples of the negative electrode substrate include a foil, a deposited film, a mesh, and a porous material, and a foil is preferable from the viewpoint of costs. Therefore, the negative electrode substrate is preferably a copper foil or a copper alloy foil. Examples of the copper foil include a rolled copper foil and an electrolytic copper foil.

The average thickness of the negative electrode substrate is preferably 2 μm or more and 35 μm or less, more preferably 3 μm or more and 30 μm or less, still more preferably 4 μm or more and 25 μm or less, and particularly preferably 5 μm or more and 20 μm or less. By setting the average thickness of the negative electrode substrate in the above range, it is possible to enhance the energy density per volume of a secondary battery while increasing the strength of the negative electrode substrate.

The negative active material layer contains a negative active material. The negative active material layer contains optional components such as a conductive agent, a binder, a thickener, and a filler, if necessary. The optional components such as a conductive agent, a binder, a thickener, and a filler can be selected from the materials exemplified for the positive electrode.

The negative active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Ta, Hf, Nb, or W as a component other than the negative active material, the conductive agent, the binder, the thickener, and the filler.

The negative active material can be appropriately selected from known negative active materials. As the negative active material for a lithium ion secondary battery, a material capable of absorbing and releasing lithium ions is usually used. Examples of the negative active material include metallic Li; metals or metalloids such as Si and Sn; metal oxides or metalloid oxides such as a Si oxide, a Ti oxide, and a Sn oxide; titanium-containing oxides such as Li₄Ti₅O₁₂, LiTiO₂, and TiNb₂O₇; a polyphosphoric acid compound; silicon carbide; and carbon materials such as graphite and non-graphitic carbon (easily graphitizable carbon or hardly graphitizable carbon). Among these materials, graphite and non-graphitic carbon are preferable. In the negative active material layer, one of these materials may be used singly, or two or more of these materials may be mixed and used.

The term “graphite” refers to a carbon material in which an average lattice spacing (d₀₀₂) of the (002) plane determined by an X-ray diffraction method before charge-discharge or in a discharged state is 0.33 nm or more and less than 0.34 nm. Examples of the graphite include natural graphite and artificial graphite. Artificial graphite is preferable from the viewpoint that a material having stable physical properties can be obtained.

The term “non-graphitic carbon” refers to a carbon material in which the average lattice spacing (d₀₀₂) of the (002) plane determined by the X-ray diffraction method before charging/discharging or in the discharged state is 0.34 nm or more and 0.42 nm or less. Examples of the non-graphitic carbon include hardly graphitizable carbon and easily graphitizable carbon. Examples of the non-graphitic carbon include a resin-derived material, a petroleum pitch or a material derived from petroleum pitch, a petroleum coke or a material derived from petroleum coke, a plant-derived material, and an alcohol derived material.

In this regard, the term “discharged state” means a state discharged such that lithium ions that can be occluded and released in association with charge-discharge are sufficiently released from the carbon material that is the negative active material. For example, it is a state where an open circuit voltage is 0.7 V or higher in a half battery that has, for use as a working electrode, a negative electrode containing a carbon material as a negative active material, and has metal Li for use as a counter electrode.

The term “hardly graphitizable carbon” refers to a carbon material in which the d₀₀₂ is 0.36 nm or more and 0.42 nm or less.

The term “easily graphitizable carbon” refers to a carbon material in which the d₀₀₂ is 0.34 nm or more and less than 0.36 nm.

The negative active material is typically particles (powder). The average diameter of the negative active material can be, for example, 1 nm or more and 100 μm or less. When the negative active material is, for example, a carbon material, a titanium-containing oxide, or a polyphosphoric acid compound, the average diameter thereof may be preferably 1 μm or more and 100 μm or less. When the negative active material is Si, Sn, an oxide of Si, an oxide of Sn, or the like, the average diameter thereof may be 1 nm or more and 1 μm or less. By setting the average diameter of the negative active material to be equal to or greater than the lower limit, the negative active material is easily produced or handled. By setting the average diameter of the negative active material to be equal to or less than the above upper limit, the electron conductivity of the active material layer is improved. A crusher, a classifier, and the like are used to obtain a powder having a predetermined particle size. A crushing method and a powder classification method can be selected from, for example, the methods exemplified for the positive electrode. When the negative active material is a metal such as metal Li, the negative active material may have the form of foil.

The content of the negative active material in the negative active material layer is preferably 60% by mass or more and 99% by mass or less, and more preferably 90% by mass or more and 98% by mass or less. By setting the content of the negative active material in the above range, it is possible to achieve both high energy density and productivity of the negative active material layer.

### (Separator)

The separator can be appropriately selected from known separators. As the separator, for example, a separator composed of only a substrate layer, a separator in which a heat resistant layer containing heat resistant particles and a binder is formed on one surface or both surfaces of the substrate layer, or the like can be used. Examples of the form of the substrate layer of the separator include a woven fabric, a nonwoven fabric, and a porous resin film. Among these forms, a porous resin film is preferable from the viewpoint of strength, and a nonwoven fabric is preferable from the viewpoint of liquid retaining property of the nonaqueous electrolyte. As the material of the substrate layer of the separator, a polyolefin such as polyethylene or polypropylene is preferable from the viewpoint of a shutdown function, and polyimide, aramid or the like is preferable from the viewpoint of resistance to oxidation and decomposition. As the substrate layer of the separator, a material obtained by combining these resins may be used.

The heat resistant particles included in the heat resistant layer preferably have a mass loss of 5% or less in the case of temperature increase from room temperature to 500° C. under the air atmosphere of 1 atm, and more preferably have a mass loss of 5% or less in the case of temperature increase from room temperature to 800° C. Inorganic compounds can be mentioned as materials whose mass loss is a predetermined value or less. Examples of the inorganic compound include oxides such as iron oxide, silicon oxide, aluminum oxide, titanium dioxide, barium titanate, zirconium oxide, calcium oxide, strontium oxide, barium oxide, magnesium oxide and aluminosilicate; nitrides such as aluminum nitride and silicon nitride; carbonates such as calcium carbonate; sulfates such as barium sulfate; hardly soluble ionic crystals of calcium fluoride, barium fluoride, and the like; covalently bonded crystals such as silicon and diamond; and substances derived from mineral resources, such as talc, montmorillonite, boehmite, zeolite, apatite, kaolin, mullite, spinel, olivine, sericite, bentonite and mica, and artificial products thereof. As the inorganic compound, a simple substance or a complex of these substances may be used alone, or two or more thereof may be mixed and used. Among these inorganic compounds, silicon oxide, aluminum oxide, or aluminosilicate is preferable from the viewpoint of safety of the energy storage device.

A porosity of the separator is preferably 80% by volume or less from the viewpoint of strength, and is preferably 20% by volume or more from the viewpoint of discharge performance. The term “porosity” herein is a volume-based value, and means a value measured with a mercury porosimeter.

As the separator, a polymer gel composed of a polymer and a nonaqueous electrolyte may be used. Examples of the polymer include polyacrylonitrile, polyethylene oxide, polypropylene oxide, polymethyl methacrylate, polyvinyl acetate, polyvinylpyrrolidone, and polyvinylidene fluoride. The use of polymer gel has the effect of suppressing liquid leakage. As the separator, a polymer gel may be used in combination with a porous resin film, a nonwoven fabric, or the like as described above.

### (Nonaqueous Electrolyte)

The nonaqueous electrolyte can be appropriately selected from known nonaqueous electrolytes. As the nonaqueous electrolyte, a nonaqueous electrolyte solution may be used. The nonaqueous electrolyte solution contains a nonaqueous solvent and an electrolyte salt dissolved in the nonaqueous solvent.

The nonaqueous solvent can be appropriately selected from known nonaqueous solvents. Examples of the nonaqueous solvent include cyclic carbonates, chain carbonates, carboxylic acid esters, phosphoric acid esters, sulfonic acid esters, ethers, amides, and nitriles. As the nonaqueous solvent, those in which some hydrogen atoms contained in these compounds are substituted with halogen may be used.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among these examples, EC is preferable.

Examples of the chain carbonate include diethyl carbonate (DEC), dimethyl carbonate (DMC), ethyl methyl carbonate (EMC), diphenyl carbonate, trifluoroethyl methyl carbonate, and bis(trifluoroethyl)carbonate. Among these examples, EMC is preferable.

As the nonaqueous solvent, it is preferable to use the cyclic carbonate or the chain carbonate, and it is more preferable to use the cyclic carbonate and the chain carbonate in combination. By using the cyclic carbonate, dissociation of the electrolyte salt can be promoted to improve ionic conductivity of the nonaqueous electrolyte solution. By using the chain carbonate, viscosity of the nonaqueous electrolyte solution can be suppressed to be low. When the cyclic carbonate and the chain carbonate are used in combination, a volume ratio of the cyclic carbonate to the chain carbonate (cyclic carbonate: chain carbonate) is preferably in a range from 5:95 to 50:50, for example.

The electrolyte salt can be appropriately selected from known electrolyte salts. Examples of the electrolyte salt include a lithium salt, a sodium salt, a potassium salt, a magnesium salt, and an onium salt. Among them, the lithium salt is preferable.

Examples of the lithium salt include inorganic lithium salts such as LiPF₆, LiPO₂F₂, LiBF₄, LiClO₄, and LiN(SO₂F)₂, lithium oxalates such as lithium bis(oxalate)borate (LiBOB), lithium difluorooxalatoborate (LiFOB), and lithium bis(oxalate)difluorophosphate (LiFOP), and lithium salts having a halogenated hydrocarbon group, such as LiSO₃CF₃, LiN(SO₂CF₃)₂, LiN(SO₂C₂F₅)₂, LiN(SO₂CF₃)(SO₂C4F₉), LiC(SO₂CF₃)₃, and LiC(SO₂C₂F₅)₃Among these, an inorganic lithium salt is preferable, and LiPF₆ is more preferable.

The content of the electrolyte salt in the nonaqueous electrolyte solution is, at 20° C. under 1 atm, preferably 0.1 mol/dm³ or more and 2.5 mol/dm³ or less, more preferably 0.3 mol/dm³ or more and 2.0 mol/dm³ or less, still more preferably 0.5 mol/dm³ or more and 1.7 mol/dm³ or less, and particularly preferably 0.7 mol/dm³ or more and 1.5 mol/dm³ or less. By setting the content of the electrolyte salt in the above range, the ionic conductivity of the nonaqueous electrolyte solution can be increased.

The nonaqueous electrolyte solution may contain an additive, besides the nonaqueous solvent and the electrolyte salt. Examples of the additive include halogenated carbonic acid esters such as fluoroethylene carbonate (FEC) and difluoroethylene carbonate (DFEC); oxalates such as lithium bis(oxalate)borate (LiBOB), lithium difluorooxalatoborate (LiFOB), and lithium bis(oxalate)difluorophosphate (LiFOP); imide salt such as lithium bis(fluorosulfonyl)imide (LiFSI); aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; vinylene carbonate, methylvinylene carbonate, ethylvinylene carbonate, succinic anhydride, glutaric anhydride, maleic anhydride, citraconic anhydride, glutaconic anhydride, itaconic anhydride, cyclohexanedicarboxylic anhydride; ethylene sulfite, propylene sulfite, dimethyl sulfite, propane sultone, propene sultone, butane sultone, methyl methanesulfonate, busulfan, methyl toluenesulfonate, dimethyl sulfate, ethylene sulfate, sulfolane, dimethyl sulfone, diethyl sulfone, dimethylsulfoxide, diethylsulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, 1,3-propenesultone, 1,3-propanesultone, 1,4-butanesultone, 1,4-butenesultone, perfluorooctane, tristrimethylsilyl borate, tristrimethylsilyl phosphate, tetrakistrimethylsilyl titanate, lithium monofluorophosphate, and lithium difluorophosphate. These additives may be used singly, or two or more thereof may be used in mixture.

The content of the additive contained in the nonaqueous electrolyte solution is preferably 0.01% by mass or more and 10% by mass or less, more preferably 0.1% by mass or more and 7% by mass or less, still more preferably 0.2% by mass or more and 5% by mass or less, and particularly preferably 0.3% by mass or more and 3% by mass or less, with respect to a total mass of the nonaqueous electrolyte solution. By setting the content of the additive falls in the above range, it is possible to improve capacity retention performance or cycle performance after high-temperature storage, and to further improve safety.

As the nonaqueous electrolyte, a solid electrolyte may be used, or a nonaqueous electrolyte solution and a solid electrolyte may be used in combination.

The solid electrolyte can be selected from any material having ionic conductivity such as lithium, sodium and calcium and being solid at normal temperature (for example, 15° C. to 25° C.). Examples of the solid electrolyte include sulfide solid electrolytes, oxide solid electrolytes, oxynitride solid electrolytes, and polymer solid electrolytes.

Examples of the lithium ion secondary battery include Li₂S-P₂S₅, LiI-Li₂S-P₂S₅, and Li₁₀Ge-P₂S₁₂ as the sulfide solid electrolyte.

The shape of the energy storage device of the present embodiment is not particularly limited, and examples thereof include cylindrical batteries, prismatic batteries, flat batteries, coin batteries and button batteries.

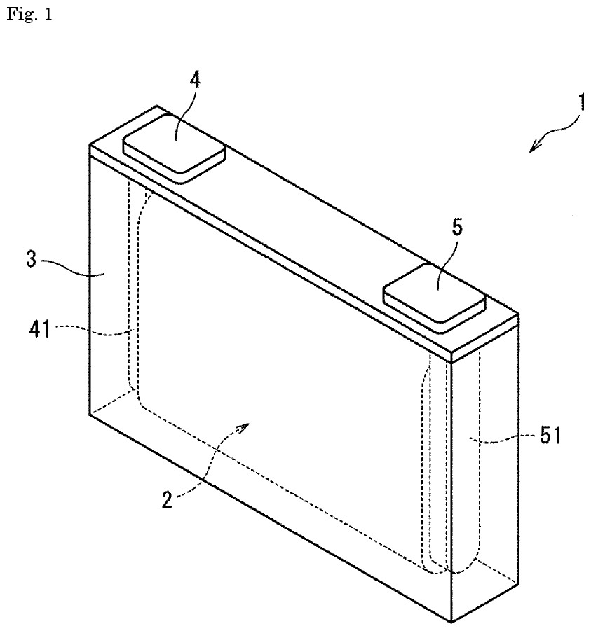

FIG. 1 shows an energy storage device 1 (nonaqueous electrolyte energy storage device) as an example of a prismatic battery. FIG. 1 is a view showing an inside of a case in a perspective manner. An electrode assembly 2 having a positive electrode and a negative electrode which are wound with a separator interposed therebetween is housed in a prismatic case 3. The positive electrode is electrically connected to a positive electrode terminal 4 via a positive electrode lead 41. The negative electrode is electrically connected to a negative electrode terminal 5 via a negative electrode lead 51.

(Pressed State of Electrode Assembly)

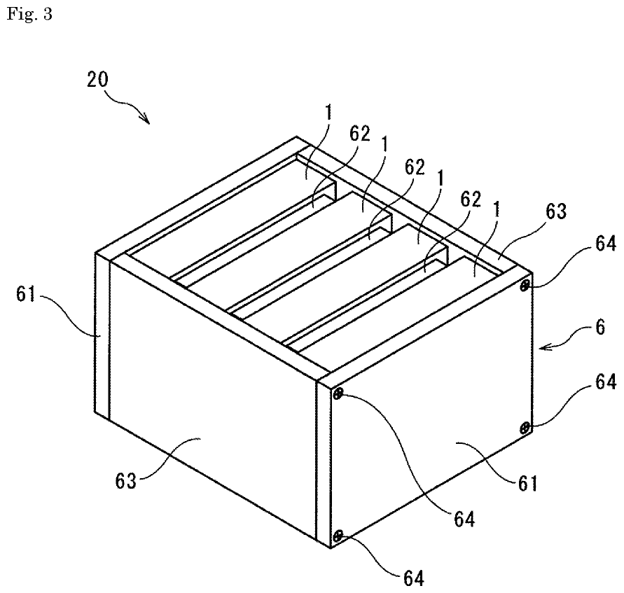

In an energy storage device 1 of the present embodiment, an electrode assembly 2 is in a pressed state in a situation where the energy storage device 1 is used. That is, the energy storage device 1 of the present embodiment is used in a state where the electrode assembly 2 is pressed. For example, the electrode assembly 2 can be brought into a state of being pressed in the thickness direction by pressing a case 3 by a pressing member 6 (see FIG. 3) as described later. The electrode assembly 2 may be brought into a state of being pressed in the thickness direction by reducing the pressure (negative pressure) by, for example, sucking gas in the case 3. The electrode assembly 2 may be brought into a pressed state by inserting a spacer (not shown) into the case 3 in addition to the electrode assembly 2. In general, the thickness of the electrode assembly 2 is increased as compared to immediately after the production of the electrode assembly 2 by impregnating the electrode assembly 2 with a nonaqueous electrolyte or by initially charging and discharging. Therefore, when the case 3 with high rigidity is used, the electrode assembly 2 with substantially the same thickness as the inner dimension of the case 3 is housed in the case 3, and the nonaqueous electrolyte is injected into the case 3 to perform initial charge-discharge, whereby the electrode assembly 2 can be brought into a state of being pressed by the case 3.

In a state where the electrode assembly 2 is pressed, the pressure applied to the electrode assembly 2 is preferably 0.1 MPa or more, more preferably 0.1 MPa or more and 2 MPa or less, and still more preferably 0.1 MPa or more and 1 MPa or less. The pressure applied to the electrode assembly 2 means a value measured by a strain gauge type load cell. By setting the pressure to be equal to or greater than the lower limit, expansion of the positive active material associated with a charge-discharge cycle can be suppressed, and generation of crack can be more reliably suppressed. On the other hand, by setting the pressure to be equal to or less than the upper limit, it is possible to suppress a decrease in durability caused by excessive pressing of the electrode assembly.

### <Configuration of Energy Storage Apparatus>

The energy storage device of the present embodiment can be mounted as an energy storage apparatus (battery module) configured by assembling a plurality of energy storage devices 1 on a power source for automobiles such as electric vehicles (EV), hybrid vehicles (HEV), and plug-in hybrid vehicles (PHEV), a power source for electronic equipment such as personal computers and communication terminals, or a power source for power storage, or the like. In this case, the technique of the present invention may be applied to at least one energy storage device included in the energy storage apparatus.

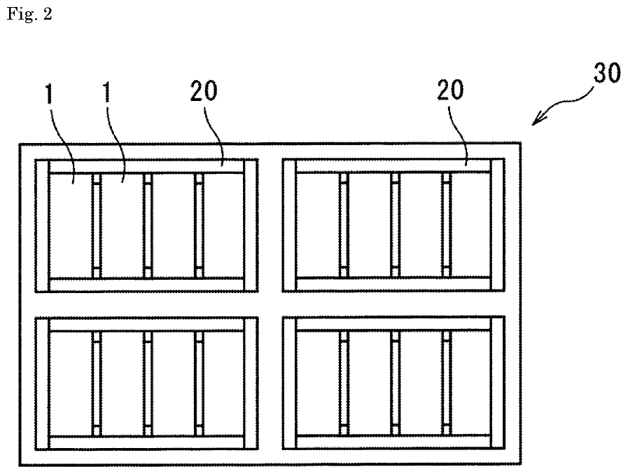

The energy storage apparatus of the present embodiment includes the energy storage device of the present embodiment described above and a pressing member, and the pressing member presses the electrode assembly by pressing the case. FIG. 2 shows an example of a battery pack 30 formed by assembling energy storage apparatuses 20 in each of which two or more electrically connected energy storage devices 1 are assembled. The battery pack 30 may include a busbar (not shown) for electrically connecting two or more energy storage devices 1, a busbar (not shown) for electrically connecting two or more energy storage apparatuses 20, and the like. The energy storage apparatus 20 or the battery pack 30 may include a state monitor (not shown) for monitoring the state of one or more energy storage devices.

FIG. 2 shows an aspect in which the energy storage apparatus 20 has a plurality of energy storage devices 1 which are prismatic batteries as shown in FIG. 1. As shown in FIG. 3, the energy storage apparatus 20 has a plurality of energy storage devices 1 whose side surface portions face each other and are arranged side by side at intervals and the pressing member 6.

### (Pressing Member)

As shown in FIG. 3, the pressing member 6 has two (that is, a pair of) pressing portions 61 which respectively press the outer surfaces of two energy storage devices 1 disposed on both outermost sides in the arrangement direction of the plurality of energy storage devices 1, one or more spacer portions 62 which are disposed between the plurality of energy storage devices 1, one or more support portions 63 which are disposed between the two pressing portions 61 along the arrangement direction and support the two pressing portions 61, and one or more pressing force adjusting portions 64 which connect the two pressing portions 61 and the one or more support portions 63 to each other and are configured so as to be able to adjust pressing force of the two pressing portions 61 with respect to the plurality of energy storage devices 1.

### [Pressing Portion]

The two pressing portions 61 comes into contact with the respective outer surfaces of the outermost two energy storage devices 1 and presses these energy storage devices 1. The pressing portion 61 is not particularly limited, and is appropriately set so as to be able to be in contact with a side surface of the energy storage device in this manner and press the energy storage device 1 as described above. Examples of the pressing portion 61 include a metal plate and a resin plate. As shown in FIG. 3, the shape of the pressing portion 61 can be, for example, a rectangular shape. In the aspect shown in FIG. 3, the pressing portion 61 has one or more (four in FIG. 3) screw holes (not shown) into which the pressing force adjusting portion 64 is screwed. In FIG. 3, the pressing force adjusting portions 64 are screwed into one (front side) pressing portion 61 of the two pressing portions 61, and the pressing force adjusting portions 64 are similarly screwed into the other (back side) pressing portion 61.

### [Spacer Portion]

The one or more spacer portions 62 are disposed between the plurality of energy storage devices 1 so as to be in contact with the plurality of energy storage devices 1, and transmit pressing force from the pressing portion 61 to the adjacent energy storage devices 1. The spacer portion 62 is not particularly limited, and is appropriately set so as to be able to transmit the pressing force to the adjacent energy storage devices 1. Examples of the spacer portion 62 include a metal plate and a resin plate. As shown in FIG. 3, the shape of the spacer portion 62 can be, for example, a rectangular shape. As shown in FIG. 3, for example, the peripheral edge of a side surface of the spacer portion 62 in contact with the energy storage device 1 can be formed smaller than the peripheral edge of a side surface of the energy storage device 1. With such a configuration, the pressing force from the pressing portion 61 can be efficiently transmitted to the energy storage device 1. The number of the spacer portions 62 is not particularly limited as long as it is one or more. For example, the number of the spacer portions 62 can be appropriately set according to the number of the energy storage devices 1 included in the energy storage apparatus 20.

### [Support Portion]

The one or more support portions 63 are connected to the two pressing portions 61 to support these pressing portions 61. The support portion 63 is not particularly limited, and can be appropriately set so as to be able to support the pressing portion 61. Examples of the support portion 63 include a metal plate and a resin plate. As shown in FIG. 3, the shape of the support portion 63 can be, for example, a rectangular shape. For example, the support portion 63 can be disposed so as to be in contact with side surfaces perpendicular to the arrangement direction in the plurality of energy storage devices 1. The support portion 63 is connected to the pressing portion 61 by the pressing force adjusting portion 64. The length of the support portion 63 in the arrangement direction can be appropriately set to such a length that the pressing force from the pressing portion 62 can be adjusted to a desired value.

The number of the support portions 63 is not particularly limited as long as it is one or more. As shown in FIG. 3, for example, the number of support portions 63 is two, and the two support portions 63 can be connected to the two pressing portions 61. In the aspect shown in FIG. 3, the support portion 63 has one or more (two on each end surface in FIG. 3) screw holes (not shown) into which the pressing force adjusting portion 64 is screwed on both end surfaces in the arrangement direction.

### [Pressing Force Adjusting Portion]

The one or more pressing force adjusting portions 64 connect the two pressing portions 61 and adjust pressing force applied to the plurality of energy storage devices 1 by these pressing portions 61. In the aspect shown in FIG. 3, the pressing force adjusting portion 64 connects the two pressing portions 61 via the support portion 63. The pressing force adjusting portion 64 is not particularly limited, and can be appropriately set so as to be able to connect the two pressing portions 61 in this manner and adjust the pressing force by these pressing portions 61.

As shown in FIG. 3, for example, the pressing force adjusting portion 64 may be formed of a screw member screwed into the pressing portion 61 and the support portion 63. As described above, in FIG. 3, the pressing force adjusting portions 64 are screwed into one (front side) pressing portion 61 of the two pressing portions 61, and the pressing force adjusting portions 64 are similarly screwed into the other (back side) pressing portion 61. In this aspect, the pressing force applied to the energy storage device 1 by the pressing portion 61 can be adjusted by adjusting a screwing amount of the pressing force adjusting portion 64 with respect to the pressing portion 61 and the support portion 63. For example, by adjusting the screwing amount of the pressing force adjusting portion 64 in a direction in which the interval between the two pressing portions 61 decreases, it is possible to increase the pressing force applied to the energy storage device 1 by these pressing portions 61. On the other hand, by adjusting the screwing amount of the pressing force adjusting portion 64 in a direction in which the interval between the two pressing portions 61 increases, it is possible to reduce the pressing force applied to the energy storage device 1 by these pressing portions 61.

As described above, when the pressing force adjusting portion 64 is formed of a screw member, the pressing force can be adjusted only by adjusting the screwing amount, so that the pressing force is easily adjusted. As described above, the pressing force can be set such that the pressure applied to the electrode assembly 2 is 0.1 MPa.

The number of pressing force adjusting portions 64 is not particularly limited as long as it is one or more. As shown in FIG. 2, for example, the number of pressing force adjusting portions 64 can be set to eight (four for each pressing portion 61).

The battery pack 30 can include one or more energy storage apparatuses 20. When the battery pack 30 includes one energy storage apparatus 20, the energy storage apparatus 20 can correspond to the battery pack 30. When the battery pack 30 includes a plurality of energy storage apparatuses 20 as shown in FIG. 2, the plurality of energy storage apparatuses 20 can be connected to each other by a connecting member (not shown).

### <Method for Manufacturing Energy Storage Device>

The method for manufacturing an energy storage device of the present embodiment is a method for manufacturing the energy storage device of the present embodiment described above, and includes pressing the electrode assembly. The manufacturing method further includes preparing an electrode assembly, preparing a nonaqueous electrolyte, and housing the electrode assembly and the nonaqueous electrolyte in a case. That is, the manufacturing method includes preparing an electrode assembly, preparing a nonaqueous electrolyte, housing the electrode assembly and the nonaqueous electrolyte in a case, and pressing the electrode assembly in a state where the electrode assembly and the nonaqueous electrolyte are housed in the case.

The preparation of the electrode assembly includes: preparing a positive electrode and a negative electrode, and forming an electrode assembly by stacking or winding the positive electrode and the negative electrode with a separator interposed therebetween.

Housing the nonaqueous electrolyte in a case can be appropriately selected from known methods. For example, when a nonaqueous electrolyte solution is used for the nonaqueous electrolyte, the nonaqueous electrolyte solution may be injected from an inlet formed in the case, followed by sealing the inlet.

As the pressing of the electrode assembly, for example, as described above, pressing of the case by the pressing member can be adopted. In this case, as described above, the case can be pressed by the pressing member so that the pressure applied to the electrode assembly is 0.1 MPa or more. Alternatively, as described above, it is also possible to press the electrode assembly by injecting the nonaqueous electrolyte and performing initial charge-discharge using a case with high rigidity and an electrode assembly with a thickness larger than the inner dimension of the case after charging and discharging.

The manufacturing method may further include initially charging and discharging the energy storage device, and the pressing may be performed after the initially charging and discharging. That is, in the manufacturing method, the energy storage device may be initially charged and discharged in a state where the electrode assembly and the nonaqueous electrolyte are housed in the case, and the electrode assembly may be pressed after the initial charge-discharge. The number of times of initial charge-discharge before pressing is not particularly set, but may be one or more times, and is preferably one time. That is, it is preferable to press the electrode assembly after the initial charge-discharge. By bringing the electrode assembly into a pressed state after the initial charge-discharge, the gas generated by the initial charge-discharge can be discharged from the inside of the electrode assembly. This can reduce initial resistance. Therefore, according to the manufacturing method, it is possible to manufacture the energy storage device in which the initial resistance is reduced and an increase in resistance associated with a charge-discharge cycle is suppressed.

### <Method for Manufacturing Energy Storage Apparatus>

A method for manufacturing an energy storage apparatus of the present embodiment includes: arranging one or more the energy storage devices described above; and bringing the arranged energy storage devices into a state of being pressed by a pressing member. For example, in the case of manufacturing the energy storage apparatus of the aspect shown in FIG. 2 and FIG. 3, the method for manufacturing the energy storage apparatus can include: arranging the plurality of energy storage devices and the spacer portions 62 disposed between the plurality of energy storage devices 1 so as to be in contact with the plurality of energy storage devices 1; bringing the two pressing portions 61 into contact with the respective outer surfaces of the two energy storage devices 1 located on both outer sides in the arrangement direction of the plurality of energy storage devices 1;

arranging one or more support portions 63 between the two pressing portions 61; and connecting each pressing portion 61 and each support portion 63 by one or more pressing force adjusting portions 64. The manufacturing method can also include preparing the energy storage apparatus 20 by bringing the plurality of energy storage devices 1 into a state of being pressed by the pressing member 6, and connecting the plurality of prepared energy storage apparatuses 20.

### OTHER EMBODIMENTS

It is to be noted that the energy storage device, the method for manufacturing an energy storage device, and the energy storage apparatus of the present invention are not limited to the embodiments described above, and various changes may be made without departing from the scope of the present invention. For example, the configuration of one embodiment can be added to the configuration of another embodiment, or a part of the configuration according to one embodiment can be replaced with the configuration according to another embodiment or a well-known technique. Furthermore, a part of the configuration of one embodiment can be removed. In addition, a well-known technique can be added to the configuration of one embodiment.

In the above embodiment, although the case where the energy storage device is used as a nonaqueous electrolyte secondary battery (for example, lithium ion secondary battery) that can be charged and discharged has been described, the type, shape, size, capacity, and the like of the energy storage device are arbitrary. The present invention can also be applied to capacitors such as various secondary batteries, electric double layer capacitors, and lithium ion capacitors.

In the energy storage device and the energy storage apparatus of the above embodiment, the aspect in which the plurality of energy storage devices are pressed by the pressing member has been described. However, an aspect in which one energy storage device is pressed by the pressing member can also be adopted.

In the energy storage apparatus of the above embodiment, the aspect in which the pressing member has the plurality of support portions has been described. However, for example, an aspect in which the pressing member has one support portion can also be adopted. In this case, for example, the support portion can be formed of one bent plate which is in contact with bottom surfaces of the plurality of energy storage devices and side surfaces on both outer sides in the direction perpendicular to the arrangement direction in the plurality of energy storage devices, and is bent such that the upper side is opened (that is, the cross-sectional shape viewed in the arrangement direction is a U shape).

In the energy storage apparatus of the above embodiment, the aspect in which the pressing force adjusting portion is formed of the screw member has been described. However, as the pressing force adjusting portion, a connecting member other than the screw member that connects the two pressing portions and one or more support portions so that the interval between the two pressing portions can be adjusted can also be adopted.

In the energy storage apparatus of the above embodiment, the aspect in which the pressing member includes the spacer portion and the support portion has been described. However, an aspect in which the pressing member does not include the spacer portion and the support portion can also be adopted. In this case, for example, the two pressing portions can be directly connected by one or more pressing force adjusting portions.

### EXAMPLES

Hereinafter, the present invention will be described more specifically with reference to Examples. The present invention is not limited to the following examples.

### Example 1

### (Preparation of Positive Electrode Plate)

As a positive active material, LiNi_{0.6}Mn_{0.2}Co_{0.2}O₂ powder with an average diameter of primary particles of 2.0 μm, a median diameter and an average diameter of secondary particles of 4.4 μm, and a BET specific surface area of 0.6 m²/g was used. A positive composite paste was prepared, which contained a positive active material, polyvinylidene fluoride (PVDF), and acetylene black (AB) at a mass ratio of 90:5:5 (in terms of solid matter). The positive composite paste was applied to both surfaces of an aluminum foil as a positive electrode substrate so that the application amount of the positive active material was 0.0128 g/cm², and dried and pressed to form a positive active material layer, thereby obtaining a positive electrode.

### (Measurement of Average Diameter of Primary Particles)

The average diameter of the primary particles was determined by measuring diameters of at least 50 primary particles in a scanning electron microscope observation image of a cross section obtained by cutting the formed positive active material layer in the thickness direction by the above-described method, and averaging the measured values.

### (Measurement of Average Diameter of Secondary Particles and Median Diameter of Positive Active Material)

The average diameter of the secondary particles is measured by determining a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013). The measured value was defined as the average diameter of the secondary particles and the median diameter of the positive active material.

### (Measurement of BET Specific Surface Area)

The BET specific surface area of the positive active material (here, secondary particles) was measured by the following method. An adsorption amount (m²) of nitrogen on a sample was determined by one point method using a specific surface area measurement apparatus manufactured by YUASA IONICS Co., Ltd. (trade name: MONOSORB). A value obtained by dividing the obtained adsorption amount by a mass (g) of the sample was defined as the BET specific surface area (m²/g). In the measurement, gas adsorption by cooling using liquid nitrogen was performed. In addition, preheating was performed at 120° C. for 15 minutes before cooling. An amount of the measurement sample loaded was 0.5 g ±0.01 g.

### (Preparation of Negative Electrode Plate)

Graphite was used as the negative active material. A negative composite paste containing the negative active material, SBR, and CMC at a mass ratio of 97:2:1 was prepared. The negative composite paste was applied to both surfaces of a copper foil as a negative electrode substrate so that the application amount of the negative active material was 0.0070 g/cm², and dried and pressed to obtain a negative electrode.

### (Preparation of Nonaqueous Electrolyte)

LiPF₆ was dissolved as an electrolyte salt at a concentration of 1.2 mol/dm³ in a nonaqueous solvent in which EC, DMC, and EMC were mixed at a volume ratio of 30:40:30 to obtain a nonaqueous electrolyte.

### (Fabrication of Energy Storage Device)

As a separator, a microporous polyolefin membrane having an inorganic heat-resistant layer formed on its surface was used. A wound electrode assembly was prepared by laminating the positive electrode and the negative electrode with the separator interposed between the electrodes and winding the laminate. The electrode assembly was housed in an aluminum case, the nonaqueous electrolyte was injected into the case, and then the case was sealed.

After the sealing, charging and discharging was performed once as initial charge-discharge, and then both side surface portions of the case were brought into a state of being pressed by the pressing member, thereby obtaining an energy storage device of Example 1. At this time, as shown in Table 1, the case was pressed with the pressing member so that the pressure applied to the electrode assembly was 0.1 MPa. In this energy storage device, the case was brought into a pressed state, whereby the electrode assembly in the case was brought into a pressed state. The pressure applied to the electrode assembly was measured by a strain gauge type load cell.

As the pressing member, one including two metal plate-shaped pressing portions arranged in parallel to each other so as to be in contact with both side surfaces of the case, and one pressing force adjusting portion which is screwed into the two pressing portions to connect the pressing portions and can adjust the interval between the pressing portions (that is, pressing force) was used. One energy storage device was brought into a state of being pressed by the pressing force adjusting portion. The pressure was adjusted by adjusting the screwing amount of the pressing force adjusting portion.

### [Example 2, Comparative Examples 1 to 3]

An energy storage device of Example 2 was prepared similarly as in Example 1 except that as the positive active material, one in which the average diameter of the primary particles, the average diameter of the secondary particles, the ratio of the average diameter of the secondary particles to the average diameter of the primary particles, the median diameter, and the BET specific surface area were the values shown in Table 1 was used. An energy storage device of Comparative Example 1 was prepared similarly as in Example 2 except that pressing by the pressing member was not performed. An energy storage device of Comparative Example 2 was prepared similarly as in Example 1 except that as the positive active material, one in which the average diameter of the primary particles, the average diameter of the secondary particles, the ratio of the average diameter of the secondary particles to the average diameter of the primary particles, the median diameter, and the BET specific surface area were the values shown in Table 1, and the pressure applied to the electrode assembly was set to the value shown in Table 1. An energy storage device of Comparative Example 3 was prepared similarly as in Comparative Example 2 except that pressing by the pressing member was not performed.

### (Measurement of Initial Discharge Capacity)

For each energy storage device obtained, constant current charge was performed at a current value of 0.1C in a temperature environment of 25° C. with an end-of-charge voltage of 4.25 V, and then constant voltage charge was performed. With regard to the charge termination conditions, charge was performed until the charge current reached 0.01C. After a pause of 10 minutes, constant current discharge was performed at a current value of 0.2C with an end-of-discharge voltage of 2.75 V. After a pause of 10 minutes, constant current charge was performed at a current value of 0.2C under a temperature environment of 25° C. with an end-of-charge voltage of 4.25 V, and then constant voltage charge was performed. With regard to the charge termination conditions, charge was performed until the charge current reached 0.01C. After a pause of 10 minutes, constant current discharge was performed at a current value of 0.2C with an end-of-discharge voltage of 2.75 V. This discharge capacity was defined as “initial discharge capacity”.

### (Charge-Discharge Cycle Test)

Each energy storage device was stored in a thermostatic bath at 60° C. for 4 hours, and then constant current charge was performed at a current value of 2 C with an end-of-charge voltage of 4.25 V, and then constant voltage charge was performed. With regard to the charge termination conditions, charge was performed until the charge current reached 0.01C. Next, after the charging, a pause of 10 minutes was provided. Thereafter, constant current discharge was performed at a current value of 2 C with an end-of-discharge voltage of 2.75 V, and a pause of 10 minutes was provided. The charging and discharging steps constituted one cycle, and the cycle was repeated 300 cycles. The charging, discharging and pausing were performed in a thermostatic bath at 60° C.

(Low Temperature Direct Current Resistance (DCR) Increase Rate after Charge-Discharge Cycle Test)

The low temperature direct current resistance (DCR) increase rate of the energy storage device after the charge-discharge cycle test was evaluated. For each energy storage device before the charge-discharge cycle test and after the charge-discharge cycle test of 300 cycles, constant current charge was performed with at a current value of 0.1C with an electric quantity corresponding to 50% of the initial discharge capacity in a thermostatic bath at 25° C. Under these conditions, the SOC (State of Charge) of each energy storage device was set to 50%. Next, each energy storage device was stored in a thermostatic bath at −10° C. for 4 hours, and then discharged at current values of 0.1C, 0.2C, and 0.3C, respectively, for 10 seconds. After completion of each discharge, constant current charge was performed at a current value of 0.1C to set the SOC to 50%. From the graph of current-voltage performance obtained by plotting the voltage 10 seconds after the start of the discharge on the vertical axis and the discharge current value on the horizontal axis, a DCR value as a value corresponding to the slope was obtained. Then, a value in which the increase rate of “DCR after charge-discharge cycle test” with respect to “DCR before charge-discharge cycle test” was expressed as a percentage was determined as “low temperature DCR increase rate (%)” by the following equation.

Low temperature DCR increase rate=(DCR after charge-discharge cycle test)/(DCR before charge-discharge cycle test)×100−100

The results are shown in Table 1 below.

TABLE 1

| | Positive active material | | | | | | | | |
|---|---|---|---|---|---|---|---|---|---|
| | | | | Average | | | | | |
| | | | | diameter | | | | | Low |
| | | Average | Average | of secondary | | | Median | Pressure | temperature |
| | | diameter | diameter | particles/average | | | diameter × | applied to | DCR increase |
| | | of secondary | of primary | diameter of | Median | BET specific | BET specific | electrode | rate at 60° C. |
| | Ni:Co:Mn | particles | particles | primary particles | diameter | surface area | surface area | assembly | for 300 cycles |
| | (molar ratio) | (μm) | (μm) | (—) | (μm) | (m²/g) | (m² · μm/g) | (MPa) | (%) |
| Example 1 | 6:2:2 | 4.4 | 2.0 | 2.2 | 4.4 | 0.6 | 2.6 | 0.1 | 1 |
| Example 2 | 6:2:2 | 10.2 | 1.0 | 10.2 | 10.2 | 0.4 | 4.1 | 0.1 | 13 |
| Comparative | 6:2:2 | 10.2 | 1.0 | 10.2 | 10.2 | 0.4 | 4.1 | 0 | 21 |
| Example 1 | | | | | | | | | |
| Comparative | 6:2:2 | 8.5 | 0.6 | 13.3 | 8.5 | 0.6 | 5.1 | 0.1 | 21 |
| Example 2 | | | | | | | | | |
| Comparative | 6:2:2 | 8.5 | 0.6 | 13.3 | 8.5 | 0.6 | 5.1 | 0 | 26 |
| Example 3 | | | | | | | | | |

As shown in Table 1, it was shown that when the ratio of the average diameter of the secondary particles to the average diameter of the primary particles is less than 11 and the electrode assembly is in a pressed state, an increase in resistance associated with a charge-discharge cycle can be suppressed. Furthermore, it was shown that when the ratio is less than 11, and the pressure applied to the electrode assembly is 0.1 MPa or more, an increase in resistance associated with a charge-discharge cycle can be further suppressed. In addition, it was shown that the product of the BET specific surface area and the median diameter of the positive active material is 4.5 or less, whereby an increase in resistance associated with a charge-discharge cycle can be further suppressed.

### DESCRIPTION OF REFERENCE SIGNS

1: Energy storage device

2: Electrode assembly

3: Case

4: Positive electrode terminal

41: Positive electrode lead

5: Negative electrode terminal

51: Negative electrode lead

6: Pressing member

61: Pressing portion

62: Spacer portion

63: Support portion

64: Pressing force adjusting portion

20: Energy storage apparatus

30: Battery pack

1. An energy storage device comprising:
an electrode assembly including a positive electrode, a negative electrode, and a separator;
a nonaqueous electrolyte; and
a case for housing the electrode assembly and the nonaqueous electrolyte,
wherein the positive electrode contains a positive active material,
the positive active material contains a plurality of particles satisfying at least one of conditions (1) and (2) below, and
the electrode assembly is in a pressed state,
(1) a plurality of primary particles that do not form secondary particles,
(2) a plurality of secondary particles formed by aggregation of a plurality of primary particles, having a ratio of an average diameter of the secondary particles to an average diameter of the primary particles that form the secondary particles of less than 11.

2. The energy storage device according to claim 1, wherein a pressure applied to the electrode assembly is 0.1 MPa or more.

3. The energy storage device according to claim 1, wherein the positive active material is a transition metal oxide containing nickel, and a product of a BET specific surface area and a median diameter of the positive active material is 4.5 or less.

4. A method for manufacturing an energy storage device including an electrode assembly including a positive electrode, a negative electrode, and a separator, a nonaqueous electrolyte, and a case for housing the electrode assembly and the nonaqueous electrolyte, the method comprising:
pressing the electrode assembly,
wherein the positive electrode contains a positive active material, and
the positive active material contains a plurality of particles satisfying at least one of conditions (1) and (2) below:
(1) a plurality of primary particles that do not form secondary particles,
(2) a plurality of secondary particles formed by aggregation of a plurality of primary particles, having a ratio of an average diameter of the secondary particles to an average diameter of the primary particles that form the secondary particles of less than 11.

5. The method for manufacturing an energy storage device according to claim 4, wherein a pressure applied to the electrode assembly is 0.1 MPa or more.

6. The method for manufacturing an energy storage device according to claim 4, further comprising initially charging and discharging the energy storage device, wherein the pressing the electrode assembly is performed after the initially charging and discharging.

7. An energy storage apparatus comprising:
one or more the energy storage devices according to claim 1; and
a pressing member,
wherein the pressing member presses the electrode assembly of the energy storage device by pressing the case.
